(19) United States
(12) Patent Application Publication
(10) Pub. No.: US 2012/0017855 A1
(43) Pub. Date: Jan. 26, 2012

(54) INTERNAL COMBUSTION ENGINE

(75) Inventors: Michael Hölscher, Wimsheim (DE); Michael Baum, Tiefenbronn-Lehningen (DE)

(73) Assignee: Dr. Ing. h.c. F. Porsche Aktiengesellschaft, Stuttgart (DE)

(21) Appl. No.: 13/178,634

(22) Filed: Jul. 8, 2011

(30) Foreign Application Priority Data
Jul. 22, 2010 (DE) 10 2010 036 576.9

(51) Int. Cl. F02B 73/00

(52) U.S. Cl. 123/2

(57) ABSTRACT

Described herein is an internal combustion engine including at least two part-engines, each part-engine having a respective crankshaft and a respective defined number of cylinders, and a coupling being positioned in each case between the crankshafts of part-engines positioned directly one behind the other, by means of which coupling the crankshafts of the part-engines can be coupled to one another and disconnected from one another, and the or each coupling, by means of which crankshafts of part-engines positioned directly one behind the other can be coupled and disconnected, being closable in order to couple the crankshafts only at a defined relative angular position between the respective crankshafts of the part-engines.

### CROSS-REFERENCE TO RELATED APPLICATIONS

This U.S. patent application claims priority to German Patent Application No. DE 10 2010 036 576.9, filed on Jul. 22, 2010, which is incorporated by reference herein in its entirety.

### FIELD OF THE INVENTION

The invention relates to an internal combustion engine comprising at least two part-engines, each part-engine having a respective crankshaft and a respective defined number of cylinders, and a coupling being positioned in each case between the crankshafts of part-engines positioned directly one behind the other, by means of which coupling the crankshafts of the part-engines can be coupled to one another and disconnected from one another.

### BACKGROUND OF THE INVENTION

A motor vehicle in the form of a hybrid vehicle with a drive unit is known from DE 10 2007 010 343 A1, which is incorporated by reference herein, which drive unit comprises an internal combustion engine and an electric machine. The internal combustion engine of the motor vehicle disclosed in this prior art comprises two internal combustion engine units, and therefore part-engines, each part-engine having a separate crankshaft and a defined number of cylinders. A first part-engine of the motor vehicle disclosed in that document can be coupled via a first coupling to a transmission, the electric machine also engaging on the transmission. A second part-engine can be coupled to the first part-engine via a second coupling. When the second coupling is closed, a drive torque can be made available by both part-engines to the drive of the motor vehicle via the transmission. When, conversely, the second coupling is open, the second part-engine is uncoupled from the output drive, so that said part-engine can be stopped, in which case drive torque can be made available at the drive of the motor vehicle only by the first part-engine of the internal combustion engine. Although it is already known from the prior art DE 10 2007 010 343 A1 to couple and disconnect two part-engines of an internal combustion engine via a coupling arranged between the crankshafts of the part-engines, the coupling to one another of previously disconnected part-engines via a coupling gives rise to difficulties.

### SUMMARY OF THE INVENTION

Starting from this consideration, it is an object of the present invention to provide a novel internal combustion engine. This object is achieved by an internal combustion engine comprising at least two part-engines, each part-engine having a respective crankshaft and a respective defined number of cylinders, and a coupling being positioned in each case between the crankshafts of part-engines positioned directly one behind the other, by means of which coupling the crankshafts of the part-engines can be coupled to one another and disconnected from one another, wherein that the or each coupling, by means of which crankshafts of part-engines positioned directly one behind the other can be coupled and disconnected, can be closed in order to couple the crankshafts only at a defined relative angular position between the respective crankshafts of the part-engines. According to aspects of the invention, the or each coupling, by means of which crankshafts of internal combustion engines positioned directly one behind the other can be coupled and disconnected, can be closed in order to couple the crankshafts only at a defined relative angular position between the respective crankshafts of the part-engines.

It is proposed with the present invention that part-engines of an internal combustion engine, between the crankshafts of which a coupling is arranged, can be coupled via the coupling only at a single defined relative angular position between the respective crankshafts. Mass-balancing problems when coupling the part-engines are thereby avoided, and the second part-engine can be combined with the first part-engine to provide a homogenous ignition and fuel injection sequence.

Preferably, the part-engines can be coupled by closing the coupling only at a defined relative angular position between the respective crankshafts and, furthermore, only at a defined relative angular position between the respective valve mechanisms. Synchronization of previously disconnected part-engines with regard to ignition sequence and fuel supply can thereby be ensured.

Preferably, sensors detect the angular positions of the crankshafts and valve mechanisms, a control unit activating the respective coupling as a function of the defined relative angular position between the crankshafts and valve mechanisms. The detection of the angular positions via sensors, and the activation of the coupling via a control unit as a function of the relative angular position between the crankshafts and the valve mechanisms thus determined, allows especially simple and precise coupling to one another of previously disconnected crankshafts of part-engines at a defined relative angular position or relative angular disposition between the respective crankshafts and valve mechanisms.

According to a first advantageous development of the invention, the or each coupling has an adjustable guide element which carries a connecting tube, the connecting tube being translationally displaceable by means of the guide element in such a manner that, at a first translational relative position between the connecting tube and the crankshafts of corresponding part-engines, the crankshafts are disconnected and, at a second translational relative position between the connecting tube and the crankshafts of the corresponding part-engines, the crankshafts are coupled, the connecting tube being able to be transferred from the first translational relative position to the second translational relative position only at a defined relative angular position between the respective crankshafts.

According to a second alternative development of the invention, the or each coupling of a crankshaft of a first part-engine comprises a non-displaceably associated first coupling element and a second coupling element associated displaceably with a crankshaft of a second part-engine, the or each coupling further comprising two energizable electromagnets which are arranged statically in a housing of the crankshafts, the two coupling elements disconnecting the crankshafts at a first translational relative position between the coupling elements when a first electromagnet is energized, and the two coupling elements coupling the crankshafts at a second translational relative position between the coupling elements when a second electromagnet is energized, and the second coupling element being able to be transferred from the first translational relative position to the second translational relative position only at a defined relative angular position between the respective crankshafts.

Both the alternative configurations set forth above of couplings by means of which crankshafts of part-engines can be coupled to one another only at a defined relative angular position or angular disposition between the respective crankshafts, are constructionally simple and reliable.

### BRIEF DESCRIPTION OF THE DRAWING FIGURES

Preferred developments of the invention are apparent from the dependent claims and from the following description. Exemplary embodiments of the invention are explained in more detail, without being restricted thereto, with reference to the drawing, in which:

FIG. 1 is a schematized representation of an internal combustion engine according to aspects of the invention;

FIG. 2 shows a schematized detail, specifically a coupling, of the internal combustion engine of FIG. 1 in a first state;

FIG. 3 shows the detail of FIG. 2 in a second state;

FIG. 4 shows an alternative schematized detail, specifically an alternative coupling, of the internal combustion engine according to aspects of the invention, and

FIG. 5 shows a further alternative schematized detail, specifically a further alternative coupling, of the internal combustion engine according to aspects of the invention.

### DETAILED DESCRIPTION OF THE PREFERRED EMBODIMENTS

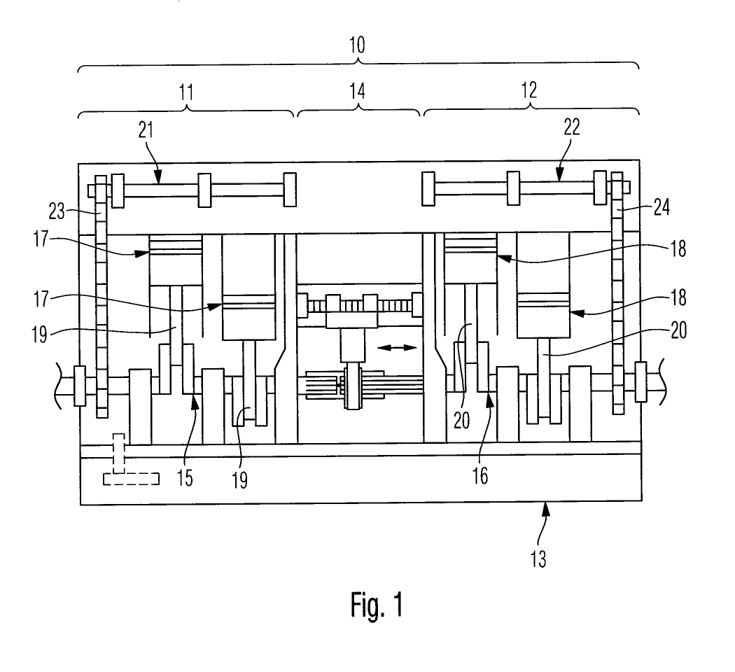

The present invention relates to an internal combustion engine comprising a plurality of part-engines. FIG. 1 shows an exemplary embodiment of an inventive internal combustion engine 10 comprising two part-engines 11 and 12, the two part-engines 11 and 12 of the internal combustion engine 10 being positioned in a common housing 13. A coupling 14, by means of which the two part-engines 11 and 12 can be coupled to and disconnected from one another, is arranged between the two part-engines 11 and 12.

Each part-engine 11, 12 of the internal combustion engine 10 has a respective separate crankshaft 15, 16 and a respective defined number of cylinders 17, 18. In the variant of FIG. 1, each part-engine 11 and 12 comprises two cylinders 17, 18 in each case, the cylinders 17, 18 being coupled via connecting rods 19, 20 to the respective crankshafts 15, 16.

It is further apparent from FIG. 1 that each part-engine 11, 12 has a respective separate valve mechanism 21, 22, it being possible for so-called gas-exchange valves of the respective cylinders 17, 18 of the part-engines 11, 12 to be actuated via the valve mechanisms 21, 22. These gas-exchange valves are inlet valves (not shown) for air or a fuel-air mixture and exhaust valves (not shown) for exhaust gas. If the part-engines 11 and 12 have a direct fuel injection system, separate fuel injection valves are present in addition to the inlet valves for air and the exhaust valves for exhaust gas. The separate valve mechanisms 21 and 22 are typically provided by so-called camshafts which, as shown in FIG. 1, are driven from the respective crankshafts 15, 16 of the part-engines 11, 12. Thus, it is apparent from FIG. 1 that the valve mechanism 21 of the part-engine 11 is coupled to the crankshaft 15, specifically via a chain drive 23 according to FIG. 1. Likewise, the valve mechanism 22 of the part-engine 12 is coupled to the crankshaft 16 thereof via a chain drive 24. Instead of the chain drives 23 and 24, the valve mechanisms 21, 22 may also be coupled to the respective crankshaft 15, 16 via a toothed belt drive, via a vertical shaft drive or via a spur gear drive.

Because they have separate crankshafts 15, 16 and separate valve mechanisms 21, 22, the part-engines 11 and 12 of the internal combustion engine 10 of FIG. 1 can be operated entirely independently of one another. Thus, it is possible, with the coupling 14 open, and therefore when the two part-engines 11, 12 are disconnected from one another, to drive into a transmission of the motor vehicle with the aid, for example, of the part-engine 12 in order to make available combustion-engine drive torque to an axle of the motor vehicle via the transmission. Independently thereof the part-engine 11, for example, can then be operated entirely independently in order, for example, to drive a generator and to make available via the generator electrical energy which can be utilized by an electric machine in order to make available electromotive drive torque to a different axle of the motor vehicle. Furthermore, with the coupling 14 closed, it is possible to make available combustion-engine drive torque to one axle of the motor vehicle using both part-engines 11 and 12.

As already mentioned, the coupling 14 is arranged between the two parts-engines 11 and 12 of the internal combustion engine 10, specifically between the crankshafts 15 and 16 of the part-engines 11 and 12. According to aspects of the invention, the coupling 14 can be closed in order to couple the crankshafts 15 and 16, and therefore the part-engines 11 and 12, to one another only at a defined relative angular position between the crankshafts 15 and 16 of the part-engines 11 and 12. This coupling together of the crankshafts 15 and 16 of the part-engines 11 and 12 via the coupling 14 takes place preferably with 0.1° of accuracy.

Moreover, the coupling together of the part-engines 11 and 12 by closing the coupling 14 not only takes place only at a defined relative angular position between the crankshafts 15 and 16 of the part-engines 11 and 12, but also only at a defined relative angular position between the valve mechanisms 21 and 22 of the part-engines 11 and 12, so that as the two part-engines 11 and 12 are coupled together a synchronization thereof with regard to ignition sequence and fuel supply, in particular to fuel injection, can be ensured.

If the part-engine 11 is in the form, for example, of a 2-cylinder part-engine in a V configuration and the part-engine 12 is also in the form of a 2-cylinder part-engine in a V configuration, the coupling 14 between the crankshafts 15 and 16 of these part-engines 11 and 12 can be closed only with a crankshaft offset of 180°, and preferably with an accuracy of 0.1°.

If the part-engine 11 is in the form, for example, of a 4-cylinder part-engine in a V configuration and the part-engine 12 is in the form of a 2-cylinder part-engine in a V configuration, the coupling 14 between the crankshafts 15 and 16 of these part-engines 11 and 12 can be closed only with a crankshaft offset of 120° between the crankshafts 15 and 16, and again with an accuracy of 0.1°.

By contrast, if the part-engine 12 is in the form, for example, of a 6-cylinder part-engine in a V configuration and the part-engine 11 is in the form of a 2-cylinder part-engine in a V configuration, the coupling 14 between the crankshafts 15 and 16 of these part-engines 11 and 12 can be closed only with a crankshaft offset of 90° between the two crankshafts 15 and 16, again with an accuracy of 0.1°.

However, if the part-engine 12 is in the form, for example, of an 8-cylinder part-engine in a V configuration and the part-engine 11 is in the form of a 2-cylinder part-engine in a V configuration, the coupling between the crankshafts 15 and 16 of the part-engines 11 and 12 can be closed only with a crankshaft offset of 30°, again with an accuracy of approximately 0.1°.

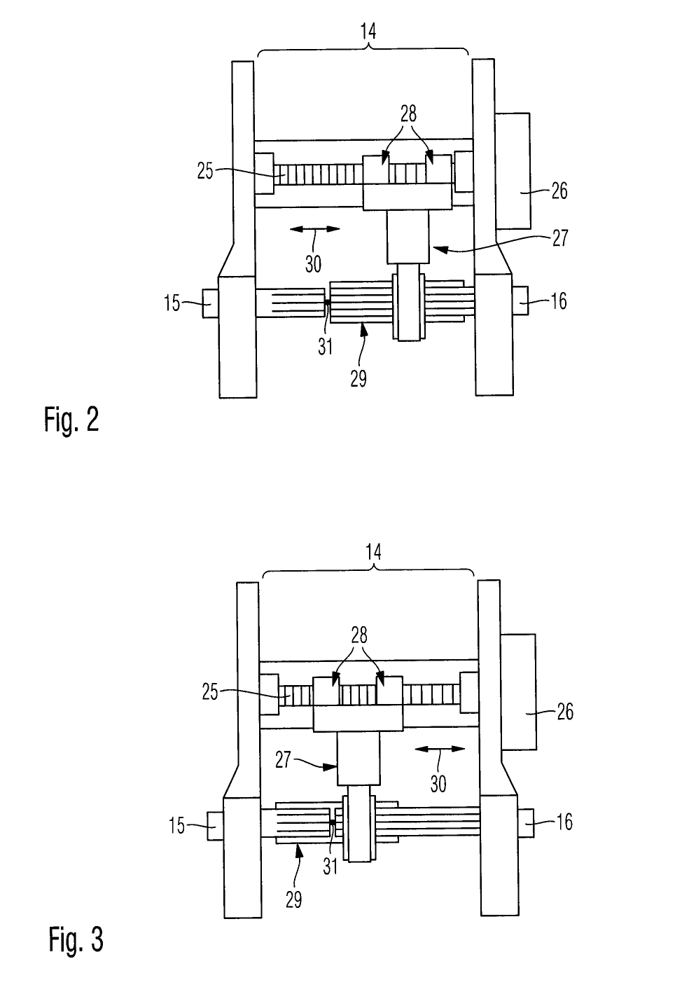

FIGS. 2 and 3 show a detail of the internal combustion engine 10 of FIG. 1 in the region of the coupling 14 via which the two crankshafts 15 and 16 of the two part-engines 11 and 12 can be disconnected and coupled, FIG. 2 showing the coupling 14 in a state in which it disconnects the two crankshafts 15 and 16, whereas FIG. 3 shows the coupling 14 in a state in which it couples the two crankshafts 15 and 16 to one another.

Thus, according to FIGS. 2 and 3, the coupling 14 shown therein has a power-adjustable guide spindle 25, which power-adjustable guide spindle 25 can be adjusted, for example, by means of an electric motor 26. The guide spindle 25 is preferably mounted in an oil bath. A guide element 27, preferably in the form of a guide table, engages on the guide spindle 25 via two spindle eyes 28, a connecting tube 29 engaging on the guide table 27. The connecting tube 29 is displaceable translationally via the guide element 27, and the guide element 27 is displaceable translationally via the guide spindle 25, relative to the crankshafts 15 and 16, in the direction of the double arrow 30, in such a manner that, at a first translational relative position (see FIG. 2) between the connecting tube 29 and the crankshafts 15 and 16 of the part-engines 11 and 12, the crankshafts 15 and 16 are disconnected, whereas at a second translational relative position (see FIG. 3) between the connecting tube 29 and the crankshafts 15 and 16 of the part-engines 11 and 12, the crankshafts 15 and 16 are coupled via the connecting tube 29.

In this case the connecting tube 29 can be transferred from the first translational relative position shown in FIG. 2 to the second translational relative position shown in FIG. 3 only at a defined relative angular position between the crankshafts 15 and 16, so that, accordingly, the two crankshafts 15 and 16 can be coupled to one another only at a single, defined relative angular position between the crankshafts 15 and 16.

The connecting tube 29 preferably has a longitudinal toothing which allows the connecting tube 29 to be transferred from the first translational relative position to the second translational relative position only at a defined relative angular position between the respective crankshafts 15 and 16, which also have a longitudinal toothing, the longitudinal toothing of the connecting tube 29 cooperating with the corresponding toothings of the crankshafts 15 and 16. This longitudinal toothing may preferably be provided by an elevation and depression of two mutually associated pairs of grooves and keys which are disposed non-symmetrically with respect to one another, in order to permit the coupling of the two crankshafts 15, 16 via the connecting tube 29 only at a defined relative angular position between the crankshafts 15 and 16.

It is apparent from FIGS. 2 and 3 that a centering pin 31 is preferably located between the two crankshafts 15 and 16. This centering pin 31 is preferably mounted via a bearing, in particular a needle bearing, in a bore of one of the crankshafts 15, 16, and firmly press-fitted in the respective other crankshaft 15, 16.

It is further apparent from FIGS. 2 and 3 that the connecting tube 29 has an internal diameter which is larger than an external diameter of the crankshafts 15 and 16, the longitudinal toothing of the connecting tube 29 then being in the form of an internal toothing which cooperates with longitudinal toothings of the crankshafts 15 and 16 configured as external toothings. In the first translational relative position the connecting tube 29 surrounds only a section of the crankshaft 16. In the second translational relative position, in which the two crankshafts 15 and 16 are coupled to one another, the connecting tube 29 surrounds sections of both crankshafts 15 and 16.

The guide spindle 25 preferably has a high pitch number, so that rapid connection of the crankshafts 15 and 16 with positional accuracy, specifically with an accuracy of 0.1°, is possible during starting of a part-engine which is to be coupled.

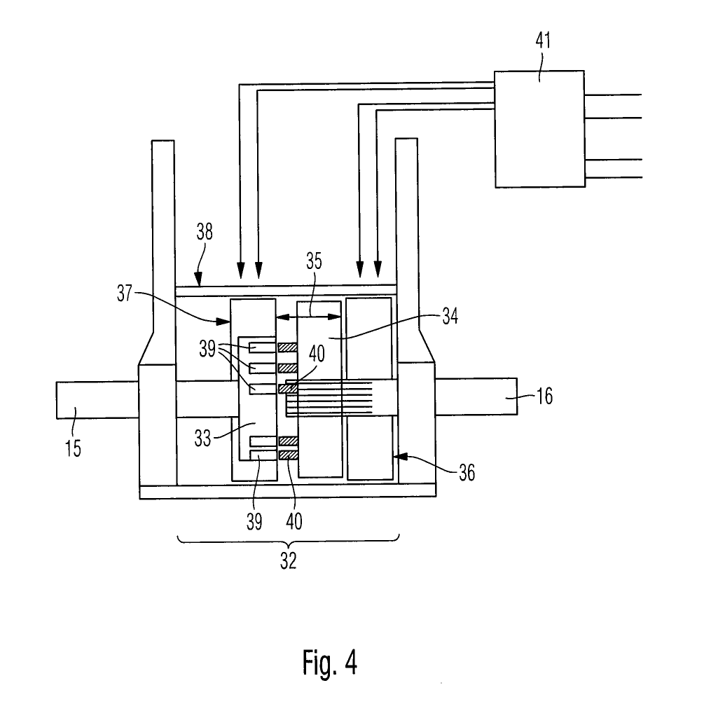

FIG. 4 shows an alternative exemplary embodiment of a coupling 32 by means of which crankshafts 15, 16 of part-engines 11 and 12 of an internal combustion engine 10 can be coupled to one another with positional accuracy, preferably with an accuracy of 0.1°, only at a defined relative angular position between the crankshafts 15 and 16.

Thus, FIG. 4 shows a coupling 32 comprising two coupling elements 33 and 34, a first coupling element 33 being associated non-displaceably with the crankshaft 11, as shown in FIG. 1, and a second coupling element 34 being associated displaceably with the crankshaft 16, as shown in FIG. 4, in such a manner that the second coupling element 34 can be displaced relative to the first coupling element 33 in the direction of the double arrow 35, that is, along a longitudinal toothing of the crankshaft 16. The coupling 32 of FIG. 4 further comprises two energizable electromagnets 36 and 37, the two electromagnets 36 and 37 being arranged non-displaceably, in a positionally fixed manner and therefore statically, on a housing 38 of the coupling 32.

When the electromagnet 36 is energized, the electromagnet 36 attracts the coupling element 34, which is coupled in a translationally displaceable manner on the crankshaft 16, in which first translational relative position between the coupling elements 33 and 34 the crankshafts 15 and 16 are disconnected. Conversely, when the electromagnet 37 is energized, the electromagnet 37 attracts the coupling element 34 and transfers the same from the first translational relative position to a second translational relative position between the coupling element 33 and 34, in which case the two coupling elements 33 and 34, and therefore the crankshafts 15 and 16, are coupled. Again, the coupling element 34 can be transferred from the first translational relative position, in which the crankshafts 15 and 16 are disconnected, to the second translational relative position, in which the crankshafts 15 and 16 are coupled, only at a defined relative angular position between the two crankshafts 15 and 16.

In the exemplary embodiment of FIG. 4, the coupling element 33 positioned non-displaceably on the crankshaft 15 is in the form of a plate with recesses 39. The coupling element 24, which is translationally displaceable on the crankshaft 16, is in the form of a plate with corresponding tooth-like or peg-like projections 40. By means of the coding between the recesses 39 and the projections 40 of the two coupling elements 33 and 34, it can be ensured that said coupling elements 33 and 34 can be coupled only at one relative angular position between the crankshafts 15 and 16.

In order to permit easy moving together and coupling together of the two coupling halves 33 and 34 at the defined relative angular position between the two crankshafts 15 and 16, the recesses 39 and projections 40 are preferably provided with chamfers.

As already set forth, the coupling together of the two crankshafts 15 and 16 of the part-engines 11 and 12 of the internal combustion engine 10 takes place via the respective coupling only at one relative angular position between the crankshafts 15, 16 and the valve mechanisms 21, 22.

Preferably, the angular position of the crankshafts 15 and 16 is detected by means of sensors (not shown) which supply corresponding measurement values to a control unit 41.

In addition to the angular position of the crankshafts 15 and 16, the angular positions of the valve mechanisms 21 and 22 are also detected with sensors, and corresponding measurement values are supplied to the control unit 41.

From the measurement values supplied, the control unit 41 determines the relative angular position between the crankshafts 15 and 16 and the relative angular position between the valve mechanisms 21 and 22, and as a function thereof is able to output operating signals in order, in the exemplary embodiment of FIG. 4, to energize or not energize the electromagnets 37 and 36. Likewise, in the exemplary embodiment of FIGS. 2 and 3 such a control unit 41 may be present for the coupling 14, which control unit 41 activates the electric motor 26 as a function of the relative angular position determined between the crankshafts 15, 16 and the valve mechanisms 21, 22.

Preferably, the coupling together of previously disconnected part-engines 11 and 12 via a coupling is executed in such a manner that a control unit 41 reads from sensors the angular positions of the two crankshafts 15 and 16 and the angular positions of the two valve mechanisms 21 and 22, preferably the angular positions of the inlet camshafts of the valve mechanisms 21 and 22. With the aid of the control unit 41, a part-engine to be coupled may first be rotated by means of a starter thereof or by means an electric machine, without enablement of the ignition and without fuel supply, until a relative angular position between the crankshafts 15, 16, while taking account of the relative angular position between the valve mechanisms 21, 22, has been reached, whereupon the two part-engines 11 and 12 can be coupled to one another. Once this relative angular position is recognized by the control unit 41, the respective coupling can be closed, in which case the ignition and the fuel supply for the two part-engines 11 and 12 of the internal combustion engine 10 are enabled. The disconnection of the part-engines 11 and 12 is preferably executed when the internal combustion engine 10 as a whole is stopped or is being operated without load.

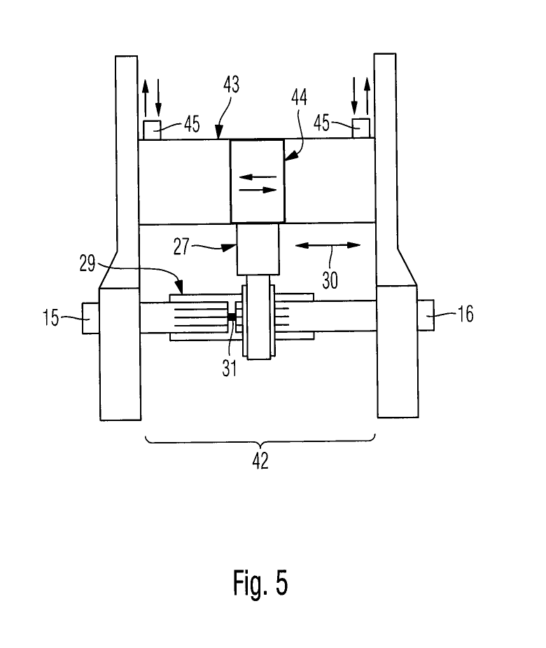

A further alternative coupling 42 is shown in FIG. 5, the coupling 42 of FIG. 5 corresponding substantially to the coupling 14 of FIGS. 2 and 3, so that to avoid repetition the same reference numerals are used for identical assemblies and only details by which the couplings 14 and 42 differ are discussed.

In the coupling 42 of FIG. 5, the displacement of the guide element 27, which carries the connecting tube 29, is performed not by means of an electric motor 26 but by means of a hydraulic cylinder 43. The hydraulic cylinder 43 comprises a hydraulically displaceable piston 44 on which the guide element 27 engages, the guide element 27, and therefore the connecting tube 29, being displaceable in the direction of the double arrow 30 as a function of the pressure difference of the hydraulic pressure acting on both sides of the piston 44.

The piston 44 is guided in the hydraulic cylinder 43 preferably by means of profiled rails. The hydraulic cylinder 43 has on each side of the piston 44 hydraulic connections 45 via which hydraulic oil can be conducted out of and into hydraulic chambers of the hydraulic cylinder 43 formed on both sides of the piston 44 in order to adjust the pressure difference on the piston 44.

The adjustment of the flow direction of hydraulic oil through the hydraulic connections 45 may be effected by means of a 2-way hydraulic valve which may be activated by the control unit 41, as described above. The necessary volume flow of hydraulic oil may be made available by means of an electric or mechanical hydraulic pump (not shown), which may also be activated by the control unit 41. The hydraulic pump may be designed with or without a pressure accumulator. Alternatively, the volume flow of hydraulic oil may also be made available by a separate engine oil pressure circuit.

### LIST OF REFERENCES

10 Internal combustion engine
11 Part-engine
12 Part-engine
13 Housing
14 Coupling
15 Crankshaft
16 Crankshaft
17 Cylinder
18 Cylinder
19 Connecting rod
20 Connecting rod
21 Valve mechanism
22 Valve mechanism
23 Chain drive
24 Chain drive
25 Guide spindle
26 Electric motor
27 Guide element
28 Spindle eye
29 Connecting tube
30 Double arrow
31 Centering pin
32 Coupling
33 Coupling element
34 Coupling element
35 Double arrow
36 Electromagnet
37 Electromagnet
38 Housing
39 Recess
40 Projection
41 Control unit
42 Coupling
43 Hydraulic cylinder
44 Piston
45 Hydraulic connection

1.-16. (canceled)

17. An internal combustion engine comprising:
at least two part-engines, each part-engine having a respective crankshaft and a respective defined number of cylinders,
a coupling being positioned in each case between the crankshafts of part-engines positioned directly one behind the other,
the crankshafts of the part-engines are configured to be coupled to one another and disconnected from one another by means of the coupling,
wherein the or each coupling, by means of which crankshafts of part-engines positioned directly one behind the other are configured to be coupled and disconnected, are configured to be closed in order to couple the crankshafts only at a defined relative angular position between the respective crankshafts of the part-engines.

18. The internal combustion engine as claimed in claim 17, wherein, if a first part-engine is in the form of a 2-cylinder part-engine in a V configuration and a second part-engine is in the form of a 2-cylinder part-engine in a V configuration, then the coupling between the crankshafts of these part-engines is configured to be closed only with a crankshaft offset of 180°.

19. The internal combustion engine as claimed in claim 17, wherein, if a first part-engine is in the form of a 4-cylinder part-engine in a V configuration and a second part-engine is in the form of a 2-cylinder part-engine in a V configuration, then the coupling between the crankshafts of these part-engines is configured to be closed only with a crankshaft offset of 120°.

20. The internal combustion engine as claimed in claim 17, wherein that if a first part-engine is in the form of a 6-cylinder part-engine in a V configuration and a second part-engine is in the form of a 2-cylinder part-engine in a V configuration the coupling between the crankshafts of these part-engines can be closed only with a crankshaft offset of 90°.

21. The internal combustion engine as claimed in claim 17, wherein, if a first part-engine is in the form of an 8-cylinder part-engine in a V configuration and a second part-engine is in the form of a 2-cylinder part-engine in a V configuration, then the coupling between the crankshafts of these part-engines is configured to be closed only with a crankshaft offset of 30°.

22. The internal combustion engine as claimed in claim 17,
wherein each coupling has an adjustable guide element which carries a connecting tube, the connecting tube being translationally displaceable by means of the guide element in such a manner that, at a first translational relative position between the connecting tube and the crankshafts of corresponding part-engines the crankshafts are disconnected, and at a second translational relative position between the connecting tube and the crankshafts of the corresponding part-engines the crankshafts are coupled,
wherein the connecting tube is configured to be transferred from the first translational relative position to the second translational relative position only at a defined relative angular position between the respective crankshafts.

23. The internal combustion engine as claimed in claim 22, wherein the connecting tube has a longitudinal toothing which permits the connecting tube to be transferred from the first translational relative position to the second translational relative position only at a defined relative angular position between the respective crankshafts, said longitudinal toothing cooperating with toothings of the crankshafts.

24. The internal combustion engine as claimed in claim 22, wherein the connecting tube surrounds only one crankshaft in the first translational relative position and surrounds at least sections of both crankshafts in the second translational relative position.

25. The internal combustion engine as claimed in claim 22, wherein the or each coupling has a power-adjustable guide spindle, the guide element which carries the connecting tube engaging on the guide spindle, and the connecting tube being translationally displaceable by means of the guide element and the guide element being translationally displaceable by means of the guide spindle.

26. The internal combustion engine as claimed in claim 22, wherein the or each coupling has a hydraulic cylinder, the guide element which carries the connecting tube engaging on the hydraulic cylinder, and the connecting tube being translationally displaceable by means of the guide element and the guide element being translationally displaceable by means of the hydraulic cylinder.

27. The internal combustion engine as claimed in claim 17, wherein the or each coupling comprises a first coupling element associated non-displaceably with a crankshaft of a first part-engine and a second coupling element associated displaceably with a crankshaft of a second part-engine,
wherein the or each coupling further comprises two energizable electromagnets which are arranged statically in a housing of the coupling, the two coupling elements disconnecting the crankshafts at a first translational relative position between the coupling elements when a first electromagnet is energized, and the two coupling elements coupling the crankshafts at a second translational relative position between the coupling elements when a second electromagnet is energized, and the second coupling element being able to be transferred from the first translational relative position to the second translational relative position only at a defined relative angular position between the respective crankshafts.

28. The internal combustion engine as claimed in claim 27, wherein one coupling element is in the form of a plate with tooth-like or peg-like projections and the other coupling element is in the form of a plate with corresponding recesses.

29. The internal combustion engine as claimed in claim 28, wherein the tooth-like or peg-like projections and the corresponding recesses have chamfers.

30. The internal combustion engine as claimed in claim 17, wherein sensors detect the angular positions of the respective crankshafts and a control unit activates the respective coupling as a function of the defined relative angular position between the respective crankshafts.

31. The internal combustion engine as claimed in claim 17, wherein the or each coupling is configured to be closed in order to couple the crankshafts only at a defined relative angular position between the respective crankshafts and only at a defined relative angular position between respective valve mechanisms of the internal combustion engine.

32. The internal combustion engine as claimed in claim 31, wherein sensors further detect the angular positions of the respective valve mechanisms and the control unit activates the respective coupling as a function of the defined relative angular position between the crankshafts and of the defined relative angular position between the valve mechanisms in such a manner that the respective coupling are configured to be closed only at a defined relative angular position between the respective crankshafts while taking account of the defined relative angular position between the valve mechanisms.
